(19) United States
(12) Patent Application Publication
(10) Pub. No.: US 2026/0201849 A1
(43) Pub. Date: Jul. 16, 2026

(54) THRUST REVERSER COMPRISING AN IMPROVED SYSTEM FOR MOVING THE MOVABLE STRUCTURE TOWARDS THE RETRACTED THRUST REVERSAL POSITION THEREOF

(71) Applicant: SAFRAN NACELLES, GONFREVILLE-L'ORCHER (FR)

(72) Inventors: Nicolas Pierre Denis MARIE, MOISSY-CRAMAYEL (FR); Laurent Georges VALLEROY, MOISSY-CRAMAYEL (FR); Vincent Jean-François PEYRON, MOISSY-CRAMAYEL (FR); Pierre Charles CARUEL, MOISSY-CRAMAYEL (FR)

(21) Appl. No.: 19/115,339

(22) PCT Filed: Sep. 29, 2023
(86) PCT No.: PCT/FR2023/051505

§ 371 Date: Mar. 12, 2026

(30) Foreign Application Priority Data
Sep. 29, 2022 (FR) 2209927

(51) Int. Cl. F02K 1/62; B64D 27/10; B64D 29/00

(52) U.S. Cl. CPC F02K 1/62; B64D 27/10; B64D 29/00

(57) ABSTRACT

The invention relates to a thrust reverser (30) for an aircraft propulsion assembly, comprising a stationary structure (31) equipped with a radially inner wall (18) delimiting a secondary flow path (21B) through which a secondary flow (20B) passes, and a movable structure (29) comprising at least one movable reverser cowl (33) having a cavity (54) delimited between a radially outer wall (50) and a radially inner wall (52) of the movable reverser cowl (33), the movable structure being translatable relative to the stationary structure along a longitudinal central axis (Al) of the reverser, between a forward direct thrust position and a retracted thrust reversal position. The reverser also comprises a controlled system (72) for moving the movable cowl (33) towards the rear, by injecting air from the secondary flow (20B) through the radially inner wall (52) of the movable reverser cowl into the cavity (54).

### TECHNICAL FIELD

The invention relates to the field of nacelles and thrust reversers for aircraft propulsion systems, and, more particularly, to systems enabling the rearward movement of the movable structure of such reversers.

### STATE OF THE PRIOR ART

Thrust reversers are devices that deflect the airflow forwards through the propulsion system, in order to shorten landing distances and limit the stress on the landing gear brakes.

Grid-type reversers currently used in the aerospace industry generally comprise deflection grids integrated into a fixed structure of the reverser, intended to be connected to a turbomachine casing. A movable structure of the reverser comprises one or more movable reverser covers, and it is mounted so that it can be moved in translation with respect to the fixed structure between a forward direct thrust position, and a reverse thrust position. In the forward direct thrust position, the deflection grids are arranged in a cavity of the movable reverser covers, and they are isolated from the secondary flow path of the propulsion system by a radially inner wall of the reverser covers. On the other hand, in the rearward reversal position, the radially retracted inner wall of the reverser covers defines a passage opening for the secondary flow path to the deflection grids.

To divert at least a portion of the secondary flow to this passage opening in the direction of the grids, the reverser is also equipped with flaps, which, when deployed, at least partially block the secondary flow path. In a known manner, this forces the air from the secondary flow through the passage opening and on to the grids, which then generate the counter-thrust air flow forwards.

There are already existing solutions for blocking off the secondary flow path using deployable membranes. For example, such a membrane configuration is known from document FR 3,076,864A1.

Conventionally, the moving structure of the reverser is moved backwards towards its reverse thrust position by means of actuators such as hydraulic cylinders or ball screws actuated by an electric motor via a flexible shaft. This conventional solution is satisfactory, but the presence of actuators as well as the means for fixing them within the reverser increase its overall mass.

To address this problem, it has been proposed to use pressurized air from the secondary flow path to generate pressure on scoop flaps, in order to cause the mobile structure to move backwards. However, this solution has proven complex to implement, and requires particular kinematics for the flaps in order to make them scoop, and this kinematics is not necessarily desired by the reverser designer. In addition, with this type of design, airtightness may be required at the upstream and downstream ends of the flap, in the folded position of the flap. This airtightness can be complicated to achieve, in particular between the downstream end of the flap and the radially inner wall of the reverser cover onto which this downstream end of the flap is hinged.

### DISCLOSURE OF THE INVENTION

In order to at least partially address the disadvantages mentioned above relating to the previous embodiments, the invention firstly relates to a thrust reverser for an aircraft propulsion system, the reverser comprising a fixed structure equipped with a wall delimiting a secondary flow path of the propulsion system radially internally, through which a secondary flow is intended to pass, the reverser also comprising a movable structure comprising at least one movable reverser cover having a cavity, preferably open towards the front, and delimited between a radially outer wall and a radially inner wall of the movable reverser cover, the radially inner wall forming a radially outer delimiting wall of the secondary flow path, the movable structure being movable in translation with respect to the fixed structure along a central longitudinal axis of the reverser, between a forward direct thrust position and a rearward reverse thrust position. According to the invention, the reverser also comprises a controlled system for moving the movable cover to the rearward reverse thrust position, by injecting air of the secondary flow through the radially inner wall of the movable reverser cover, into said cavity.

The invention thus provides a controlled system for moving the movable structure based on a simple design that is reliable, easy to set up, and low in mass. Indeed, the control allowing air from the secondary flow to enter the cavity of the movable cover can be particularly simple to achieve, for example in the form of a sealing part associated with a simple controlled latch, as will be detailed in the following. The air of the secondary flow can thus easily enter the cavity by passing through the radially inner wall of the movable cover, under high pressure causing the movable thrust reverser cover to move backwards.

The controlled displacement system makes it possible firstly to generate a pulse at the beginning of the opening stroke of the movable structure, towards its rearward reverse thrust position. It can also make it possible to contribute at least partially to moving the movable structure during the continuation of this opening stroke. It is noted that during the continuation of this opening stroke, other factors and/or means make it possible to ensure the movement to the rear, such as air drag on the aerodynamic outer surface of the movable cover, the depression at the rear thereof, the introduction of pressurized air from the secondary flow path directly into the cavity through the opening created by the receding of the cover, or when the external air rushes through the scoop into the opening created at the front of the movable cover, or the possible presence of an actuator which would then be smaller than those normally encountered. Nevertheless, the invention is preferably implemented without an actuator for the opening stroke in flight, although a smaller-sized actuator can nevertheless be retained for test operations and/or to allow ground maintenance operations with the movable structure in the rearward position. In addition, an actuator may be provided to ensure the closing stroke of the movable structure of the reverser, corresponding to its movement from the reverse thrust rearward position, to the direct thrust forward position.

Furthermore, the invention does not require the use of scooping flaps, but conversely, the design of the means for closing off the secondary flow path remains advantageously free. Nevertheless, scooping flaps can be retained, without departing from the scope of the invention.

To cause the movable cover to move backwards, the air of the secondary flow passes through the radially inner wall of this cover, for example via one or more air passages through the wall. In a direct jet, airtightness is easy to achieve for these through air passages, thus preventing the unwanted introduction of air into the cavity of the movable cover.

The invention preferably provides at least one of the following optional technical features, taken alone or in combination.

Preferably, the controlled displacement system includes:
an air passage through the radially inner wall of the movable cover;
a closing part fitted to the movable cover, the part including a portion for closing the air passage;
a control device, such as a simple controlled latch, allowing the closing part to be held in the closing position of the air passage, and releasing this closing part so as to allow the injection of air from the secondary flow through the radially inner wall of the reverser movable cover, into said cavity.

Preferably, the closing part is mounted movably on the radially inner wall, being arranged radially inwardly with respect to the latter, between the closing position of the air passage in which the closing part is folded against the radially inner wall, and a protruding position radially inwardly in the secondary flow path, in which it frees the air passage and in which it forms, preferably with its upstream axial end and together with the radially inner wall, an opening for introducing air from the secondary flow open axially towards the upstream direction.

Alternatively, the closing part is mounted movably on the radially inner wall, being arranged radially outwards with respect to the latter, therefore in said cavity, between the closing position of the air passage in which the closing part is folded against the radially inner wall, and a protruding position radially outwards, in which it releases the air passage.

Preferably, the closing portion of the air passage is centered within the closing part.

Preferably, in the reverse thrust position of the movable structure, the fixed structure of the reverser and an upstream end of the radially retracted inner wall of the reverser movable cover leave an opening for air to pass through the secondary flow path, the thrust reverser also comprising means for closing off the secondary flow path, designed to divert at least a part of the secondary flow towards the passage opening.

Preferably, the closing part is a closing flap of the secondary flow path, belonging to said closing means, or the closing part is an interflap part for reconstituting the secondary flow path, arranged circumferentially between two closing flaps of said closing means.

Preferably, the reverser comprises one or more air passages through the radially inner wall, the number thereof being between one and six, distributed circumferentially about the central longitudinal axis, in a regular or irregular manner.

Preferably, the fixed structure of the reverser comprises at least one deflection grid arranged, in a forward direct thrust position of the movable structure, in the cavity of the movable cover, being isolated from the secondary flow path by the radially inner wall of the reverser cover. Alternatively, the deflection grid(s) could be integrated into the movable structure of the reverser, without departing from the scope of the invention.

Preferably, the reverser also includes a device for damping the opening limit of the movable cover, in its movement from the forward direct thrust position to the reverse thrust position. These damping means may be incorporated into additional cylinders for opening or closing the movable cover.

Preferably, the reverser includes means for absorbing the counter-thrust forces between the movable structure and the fixed structure, generated on the means for closing the flow path and the movable structure. These means may be shared with the damping device and/or the additional opening and closing cylinders, or may be separate means such as stops at the slide rails or dedicated telescopic rods.

The invention also relates to an aircraft propulsion system, comprising a turbomachine and a nacelle comprising at least one fan cowling, as well as a thrust reverser as described above.

The invention also relates to a method for controlling such a thrust reverser. To cause the moving structure to move from its forward direct thrust position to its reverse thrust position, the method comprises a step of controlling the moving system, such that air from the secondary flow is injected through the radially inner wall, into said cavity of the movable cover, in order to cause it to move towards the reverse thrust position.

Other advantages and features of the invention will appear in the non-limiting detailed description given below.

### BRIEF DESCRIPTION OF THE DRAWINGS

The following detailed description refers to the attached drawings in which:

FIG. 1 is a schematic half-view longitudinal cross-section of a propulsion system, comprising a thrust reverser according to a preferred embodiment of the invention, represented in a direct thrust configuration;

FIG. 2 is a schematic half-view longitudinal cross-section of the reverser fitted to the propulsion system shown in FIG. 1, with the reverser shown in direct thrust configuration;

FIG. 3 is a schematic half-view of the reverser shown in FIG. 2, with the reverser represented in an intermediate configuration between the direct thrust configuration, and the reverse thrust configuration;

FIG. 3A is a schematic half-view similar to that of the previous figure, with the reverser represented in the reverse thrust configuration;

FIG. 4 is a perspective view of the reverser shown in FIGS. 2 to 3A, shown in a direct thrust configuration;

FIG. 4A is a schematic view showing the alternation, according to the circumferential direction of the reverser, between the secondary flow path flaps and the inter-flap parts;

FIG. 5 is a perspective view of the reverser shown in FIG. 4, represented in reverse thrust configuration;

FIG. 6 is a schematic half-view in longitudinal cross-section similar to that of FIG. 2, in another sectional plane, showing the controlled system for moving the movable cover in more detail, and in the form of a preferred embodiment of the invention;

FIG. 7 is a schematic half-view in longitudinal cross-section similar to that of FIG. 6, with the reverser still represented in direct thrust configuration, but just before the beginning of the opening stroke of the reverser movable covers;

FIG. 8 is a schematic half-view in longitudinal cross-section similar to that of FIG. 6, with the reverser represented in intermediate configuration between the direct thrust configuration, and the reverse thrust configuration; and

FIG. 9 is a schematic half-view in longitudinal cross-section similar to that of FIG. 8, with the reverser being in the form of an alternative.

### DESCRIPTION OF THE EMBODIMENTS

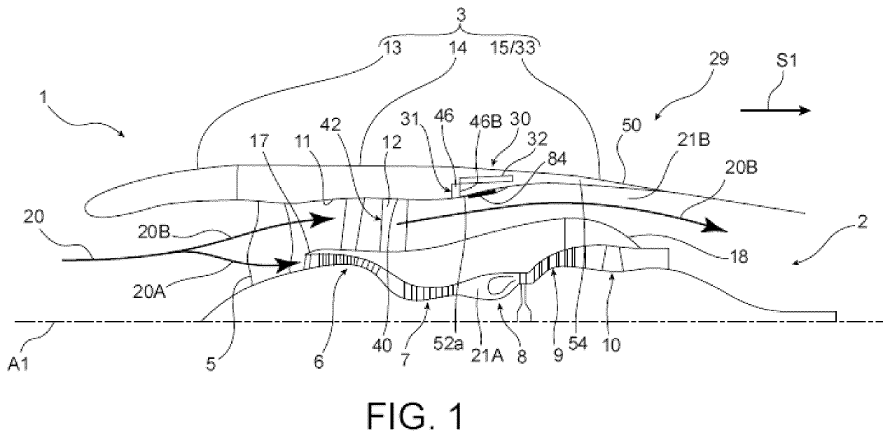

An aircraft propulsion system 1 is shown in FIG. 1, having a central longitudinal axis A1.

In the following, the terms “upstream” and “downstream” are defined relative to a general direction S1 of flow of gases through the propulsion system 1, along the axis A1 when it generates thrust. These terms “upstream” and “downstream” may be substituted by the terms “front” and “rear”, respectively, with the same meaning.

The propulsion system 1 comprises a turbomachine 2, a nacelle 3 as well as a mast (not shown), intended to connect the propulsion system 1 to a wing (not shown) of the aircraft.

The turbomachine 2 is in this example a double-flow, double-body turbojet comprising, from the front to the rear, a blower 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet 2 has a fan housing 11 connected to the gas generator by structural arms 12.

The nacelle 3 comprises a front section forming an air inlet 13, a middle section that includes two fan cowlings 14 enveloping the fan housing 11, and a rear section 15.

In operation, an air flow 20 enters the propulsion system 1 through the air inlet 13, passes through the blower 5 then divides into a primary flow 20A and a secondary flow 20B. The primary flow 20A flows into a primary gas circulation flow path 21A passing through the gas generator. The secondary flow 20B flows into a secondary flow path 21B surrounding the gas generator. The secondary flow path 21B is delimited radially inwards by a fixed internal sheathing that surrounds the gas generator. In this example, the fixed inner fairing comprises a first section 17 belonging to the middle section 14, and a second section 18 extending backwards from the first section 17, so as to form a part of the rear section 15. This second section 18 is an integral part of a fixed structure of a thrust reverser which will be described below. This same section will subsequently be referred to as the radially internal delimiting wall 18 of the secondary flow path 21B (and conventionally, it is also referred to as IFS (Inner fixed structure).

Radially outwards, the secondary flow path 21B is delimited by the fan housing 11, and, in the configuration of FIG. 1, by one or more movable reverser covers 33 forming a part of the rear section 15 of the nacelle 3, and which will be described in the following. More precisely, between the fan housing 11 and the reverser covers 33, an outer ferrule 40 of an intermediate housing 42 is provided, the latter comprising the aforementioned structural arms 12, the radially outer end of which is fastened to this ferrule 40. It therefore also contributes to delimiting the secondary flow path 21B radially outwards, by being located in the axial extension downstream of the fan housing 11.

The nacelle 3 therefore comprises a thrust reverser 30 centered on the axis A1 and comprising, on the one hand, a fixed structure 31 integral with the fan housing 11, and, on the other hand, a structure 29 that is movable with respect to the fixed structure 31. The fixed structure 31 includes for example a front frame 46 which firmly connects it to the fan housing 11, preferably via a knife flange assembly located downstream of the outer shell 11. This front frame 46 contains a profiled aerodynamic part, referred to as the deflection edge 46B, which guides the reverse jet flow.

Here, the fixed structure 31 also includes a plurality of deflection grids 32 arranged adjacent to one another around the axis A1, according to a circumferential direction of the reverser 30 and the propulsion system 1. Furthermore, the movable structure 29 comprises the aforementioned movable reverser covers 33, for example two covers 33 each extending over an angular amplitude of about 180°. This two-cover configuration 33 is particularly suitable in the case of a nacelle design in which the covers/walls 18 are also articulated, the reverser 30 then having a so-called “D” architecture, known as a “D-duct”. In this architecture, the covers 18, 33 are connected so as to open/close simultaneously during maintenance operations on the engine. Nevertheless, other architectures are possible, such as a so-called “C” architecture, known as a “C-Duct”, or “O” architecture, known under as an “O-duct”.

Each movable reverser cover 33 includes a radially outer wall 50, forming an outer aerodynamic surface of the reverser and the nacelle, this surface being surrounded by the outside air. Each cover 33 also comprises a radially inner wall 52 participating in the delimitation of the secondary flow path 21B radially outwards. This wall 52 is located in the downstream continuity of the outer shell 40 of the intermediate housing. The two walls 50, 52 define a cavity 54, preferably open axially forwards at the upstream end of the reverser cover 33.

FIG. 1 shows the reverser 30 in a forward thrust configuration, referred to as “direct jet”, corresponding to a standard flight configuration. In this configuration, the covers 33 of the movable structure 29 are in a closed position, so-called advanced thrust or “direct jet” position, in which these reverser covers 33 are supported on the fixed structure 31, in particular on the deflection edge 46B forming an integral part thereof. Indeed, in the direct thrust configuration, the upstream end 52a of the radially inner wall 52 of each cover 33 is axially supported against the deflection edge 46B.

The holding of the movable cover 33 in the forward direct thrust position is ensured by means of latching this cover onto the fixed structure 31 of the reverser. These controlled latching means (not shown) are conventional, so are described in more detail. By way of example, active latches capable of unlocking under load may be used to counteract the compressive force of a seal between the movable structure and the deflection edge. This type of latch can supercharge the seal so that the unlocking can then be controlled.

The movable structure 29 can thus be moved in translation with respect to the fixed structure 31 along the axis A1 of the reverser, between the forward direct thrust position shown in FIG. 1, and a reverse thrust position which will be described in the following. In the forward direct thrust position of the movable structure 29, the deflection grids 32 are arranged in the cavity 54 of the reverser covers 33, being isolated from the secondary flow path 21B by the radially inner wall 52 of these reverser covers. This wall 52, forming the outer wall of the secondary flow path, is also referred to as an acoustic inner panel.

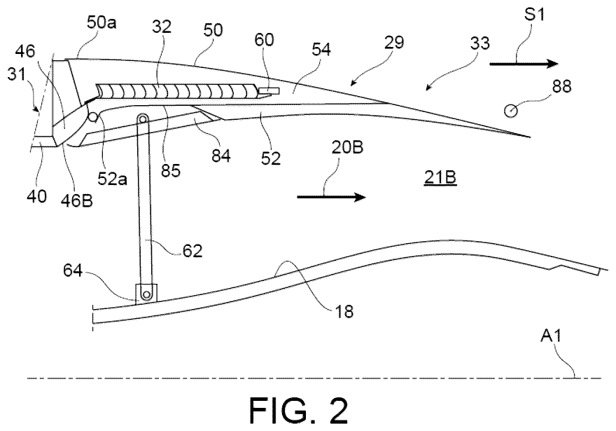

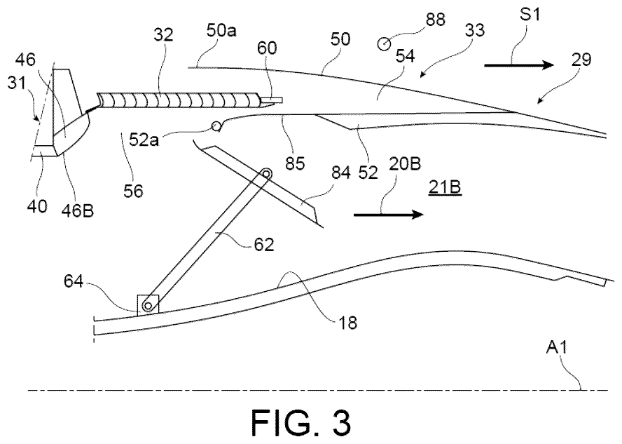

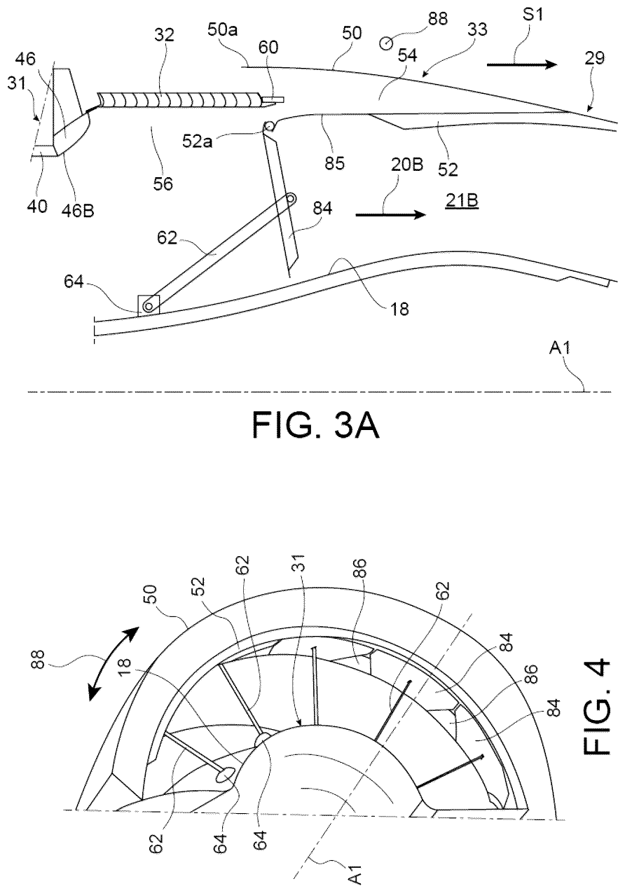

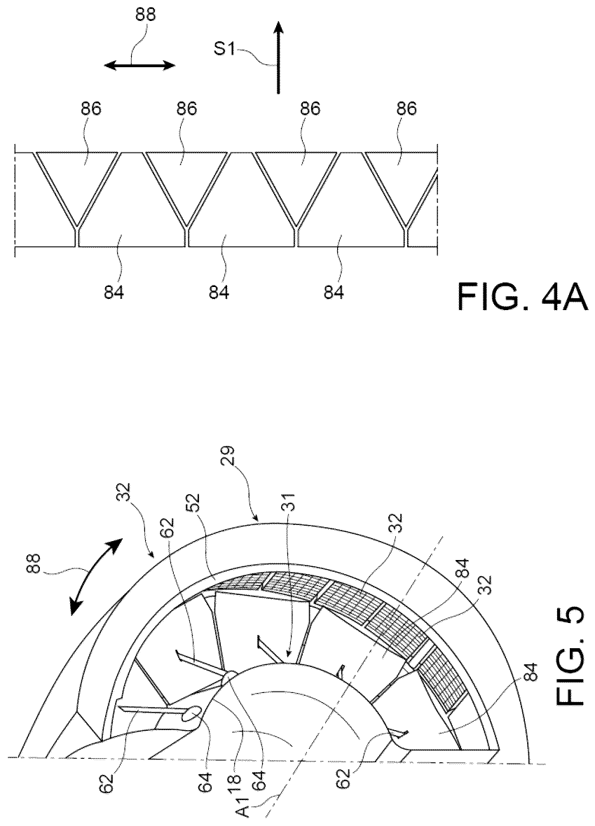

This direct thrust configuration is also shown in FIGS. 2 and 4, while the reverse thrust position of the movable structure 29 is shown in FIGS. 3A and 5. An intermediate position is shown in FIG. 3. In FIGS. 3 and 3A, it is shown that the recessed internal acoustic panel 52 of the reverser covers allows a passage opening 56 to appear upstream from the secondary flow path 21B to the deflection grids 32, connected to each other by a rear frame 60 of annular support or in the form of an annular section. The opening 56 is therefore also delimited upstream by the deflection edge 46B, which flares radially outwards going backwards, to channel an air flow intended to pass through the grids 32 when the mobile system is in this rearward reverse thrust position. In other words, the deflection edge 46B gradually moves away from the axis A1 from the front to the rear, to guide/deflect the air towards the grids 32 in reverse thrust configuration. Downstream, the passage opening 56 is delimited in particular by the upstream end 52a of the radially inner wall 52.

In order to divert at least a portion of the secondary flow 20B to the passage opening 56 defined axially between the deflection edge 46B and the upstream end 52a of the radially inner wall 52 of each cover 33, the reverser 30 includes closing means of the closing flap type 84. The latter are for example each articulated at their upstream end on the upstream end 52a of the wall 52, and also articulated in a central area on a connecting rod 62, which itself is articulated with the wall 18. In this configuration, these are conventional, non-scooping flaps 84. Nonetheless, such open flaps are conceivable, with their downstream end articulated on the wall 52.

It is noted that a mixed solution integrating both flaps and membranes for closing the flow path remains possible, without departing from the scope of the invention.

As best shown in FIG. 2, when the movable structure 29 occupies its forward direct thrust position, each flap 84 is arranged in a front recess 85 of the radially inner wall 52. This recess 85 makes it possible to maintain an aerodynamic continuity in the radially outer delimitation of the secondary flow path 21B, in the direct thrust position. At this recess 85, the wall 52 may be without acoustic protection, but this may be reconstituted on the constituent elements of the means for closing the secondary flow path, which will be described in the following.

When the cover 33 moves backwards, the connecting rod 62 pivots the flap 84 around its hinged front end, causing this flap to enter the secondary flow path 21B, radially inwards. Thus, at least a portion of the secondary flow path 21B is sealed by the flaps 84, thereby diverting at least a portion of the secondary flow 20B towards the passage opening 56 in the direction of the grids 32.

In this respect, it should be noted that each flap control rod 62 is mounted on the wall 18, preferably via a pivot or ball joint connection 64. This connection 64 can be made using a fitting fixed to the fixed wall 18 and cooperating with a radially internal end of the connecting rod 62. The connecting rods 62 are circumferentially spaced apart from each other within the secondary flow path 21B, and their number can vary, for example according to the number of flaps to be controlled.

Each connecting rod 62 is therefore designed to move from a protruding position radially in the secondary flow path 21B, a position shown in FIGS. 2 and 4 which is adopted when the movable structure 29 occupies its forward direct thrust position, to a position folded downwards, shown in FIGS. 3A and 5 adopted when the movable structure 29 occupies its reverse thrust position.

Conventionally, the flaps 84 follow one another according to the circumferential direction 88 of the reverser, with respect to the axis A1. Each flap 84 can have a general triangular or trapezoidal shape, such that in a reverse thrust configuration, their circumferential edges are adjacent in pairs, or substantially adjacent, to seal the secondary flow path 21B as best as possible. In the direct thrust configuration, the circumferential edges of the flaps 84 are therefore far from each other, and the spaces delimited circumferentially between them are filled by inter-flap parts 86, shown in FIGS. 4 and 4A. The inter-flap parts 86 thus make it possible to reconstruct the flow path 21B between the flaps 84, to obtain a better aerodynamic performance. They also have a general triangular or trapezoidal shape, oriented in a direction opposite to that of the flaps 84.

It should be noted that in a conventional grid reverser, the movable structure slides into the fixed structure via a rail/slide system that guides the movable structure from the front to the rear during the opening phase of the reverser, and from the rear to the front during the closing phase. A rearward force applied to the moving structure of the reverser therefore causes its displacement to the rear, with respect to the fixed structure. This force is usually generated by conventional actuators such as cylinders or ball screws.

In contrast, one of the particularities of the invention is that the reverser is not fitted with conventional actuators allowing the movable structure 29 to be moved backwards, from its forward direct thrust position to its reverse thrust position. In other words, unlike conventional designs, there is no provision for a cylinder or ball screws to generate and control the entire opening stroke of the movable covers 33 to the reverse thrust position, between their two extreme positions. Consequently, there is also no provision for a motor or pump that would provide the hydraulic, electrical or pneumatic energy to actuate these cylinders or ball screws.

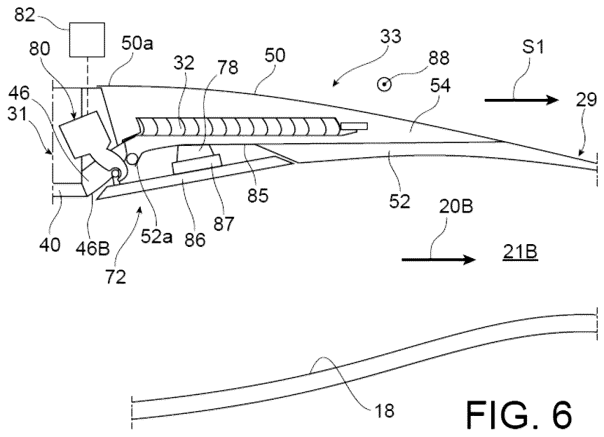

Specific means are thus provided to cause the rearward movement of each movable cover 33, as will be described below with reference to FIGS. 6 to 8, corresponding to other more detailed views of the reverser according to the preferred embodiment previously described with reference to FIGS. 1 to 5.

Indeed, the reverser comprises, for each movable cover 33, a controlled system 72 for moving this movable cover rearwards, by injecting air from the secondary flow 20B through the radially inner wall 52 of the cover, into its cavity 54.

To this end, the system 72 is firstly equipped with at least one air passage 78 through the wall 52, downstream of its front end 52a. This air passage 78 can for example take the form of a through hole or a scoop. Preferably, the air passage 78 opens into the recess 85, being axially centered therein. In the case of a scoop, it is preferably of dynamic design, for example of the NACA type (developed by the National Advisory Committee for Aeronautics), and designed to scoop air from the secondary flow 20B. The passage 78 also opens into the cavity 54 of the movable cover. Preferably, there are several air passages 78 in the wall 50 of each cover, for example up to six passages per cover 33, distributed circumferentially in a regular or irregular manner around the axis A1.

The system also includes a closing part fitted to the movable cover, formed herein by one of the inter-flap parts 86. Such a part 86 is then provided for each air passage 78, and it is hinged onto the wall 52, by its rear end. It is noted that the other inter-flap parts 86, which do not form part of the controlled system 72, are intended to remain fixed with respect to the wall 52, by being fixed to it radially on the inside.

Each closing part 86 includes a closing portion 87 of the air passage, preferably provided with a sealing device of the gaskettype intended to cooperate with the entire contour of the associated air passage 78. This closing portion 87 is preferably centered on the closing part 86, in the circumferential direction and/or in the axial direction.

The system 72 further comprises a control device 80, of the controlled latch type, for keeping the closing part 86 in the closing position of the air passage, shown in FIG. 6. In this position, the seal integrated into the closing portion 87 makes it possible to prevent air from the secondary flow from entering the cavity 54 of the movable cover. Of course, the seal could alternatively be provided over the entire contour of the air passage 78, and be crushed by the closing portion 87 when the part 86 occupies its closing position.

The control device 80 also makes it possible to release this closing part 86 so as to allow the injection of air from the secondary flow 20B through the passage 78, into said cavity 54, as will be explained below.

The latch 80 is controlled by a control system 82, for example FADEC (Full Authority Digital Engine Control). The control system 82 is capable of delivering an electrical signal to the latch so as to switch it from a closed position to an open position, and vice versa.

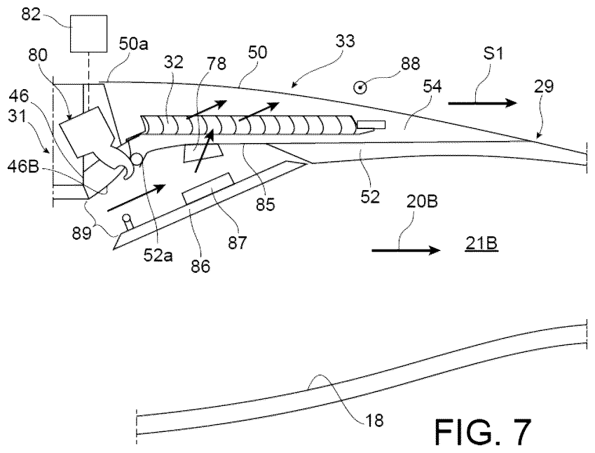

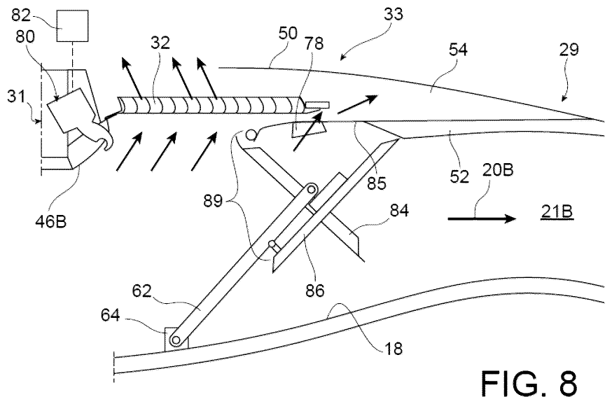

As indicated previously, the closing part 86 formed by the inter-flap part is mounted movably on the wall 52, being arranged radially inwardly with respect to the latter, between the closing position of the air passage of FIG. 6 in which the closing part is folded against the wall 52, and a protruding position radially inwardly in the secondary flow path 21B shown in FIGS. 7 and 8, in which it opens the air passage. In this same position, the closing part 86 forms, with its upstream axial end and together with the wall 52, an air introduction opening of the secondary flow 89, opened axially upstream. This opening 89 enlarges as the closing part 86 dips radially inwards into the secondary flow path 21B.

In flight, when the reverser is in direct thrust configuration, the latch 80 is held in the closed position by the control system 82. As a result, the closing part 86 remains held by this latch 80 in its closing position, in which air cannot circulate through the passage 78. No sample is therefore taken from the secondary flow 20B by the passage/scoop 78.

When the reverser is to be switched into the reverse thrust configuration, the movable structure 31 is moved from its forward direct thrust position to its reverse thrust position, and for this purpose, not only is each movable cover 33 unlatched from the fixed structure 31 of the reverser, but also a control of the latch 80 is carried out.

Indeed, the control system 82 opens the latch 80, which causes the closing part 86 to switch to its protruding position shown in FIG. 7, under the effect of the aerodynamic forces exerted by the secondary flow on this part 86. Elastic means may optionally be added to further force the switching of the part 86 into the secondary flow path 21B, after unlatching the latch 80.

As soon as the closing part 86 begins to switch, the air inlet opening of the secondary flow 89 appears, simultaneously releasing the passage of air 78 through the wall 52. The part 86 can then fulfill a scoop function, and this allows a portion of the air from the secondary flow 20B to reach the cavity 54, passing through the released air passage 78.

This thus ensures an injection of this air from the secondary flow into the cavity 54, and due to the high pressure of this air on the surfaces of the walls 50, 52 of the cover 33 inside the cavity 54, this cover 33 moves rearwards towards its reverse thrust position, as shown in FIG. 8.

Thus, the controlled displacement system 72 specific to the invention makes it possible to generate a pulse at the beginning of the opening stroke of the movable cover 33 in a simple, reliable and efficient manner. The pressure of the air on the protruding closing part 86, and of the air passing through the passage 78 to enter the cavity 54, can also help to move the movable cover during the continuation of this opening stroke, even after a significant opening of the movable structure 33 as shown in FIG. 8.

The further opening stroke of the movable cover 33 is nevertheless preferably carried out under the effect of other principles, such as the drag of air on the outer aerodynamic surface of the wall 50, or the depression observed at the rear of the cover 33, or by introducing outside air or air from the secondary flow into the cavity 54, through the upstream axial opening between the two walls 50, 52.

A conventional type of actuator, but small in size, could nevertheless be retained to ensure this opening limit in-flight, even if this is not the preferred solution. The presence of such a smaller actuator could also be justified for pre-flight testing and/or to authorize ground maintenance operations with the movable structure 29 in the rearward position.

In addition, an actuator can be provided to ensure the closing stroke of the movable structure 29, corresponding to its movement from the rearward reverse thrust position, to the forward direct thrust position.

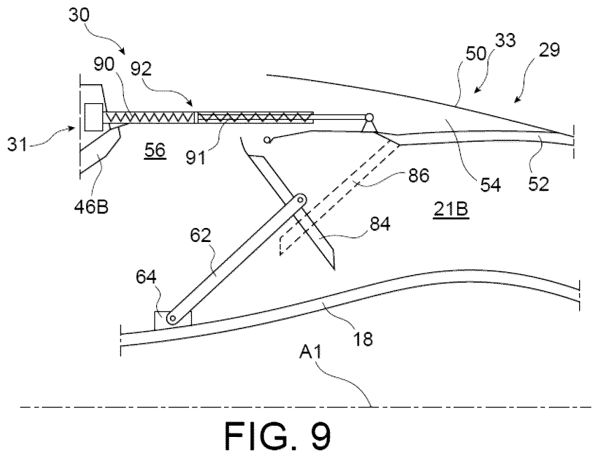

FIG. 9 shows an alternative. Between the fixed structure 31 and the movable structure 29, a damping device 92 is provided for the opening end position of the movable cover 33, for example in the form of a mechanical cylinder equipped with one or more damping springs 91. Within this device 92, or in a separate device, mechanical means for pulsing the opening stroke of the movable cover 33 can also be provided, preferably also in the form of elastic means such as one or more impulse springs 90. The device 92 can for example be installed circumferentially between the deflection grids 32 (not shown in FIG. 9), and one or more of these devices 92 is fitted to each of the two movable covers 33.

These damping means may be incorporated into additional opening or closing cylinders or ball screws. Preferably, the reverser includes means for taking up the counter-thrust forces between the movable structure and the fixed structure generated on the means for closing the flow path and the movable structure. These means may be shared with the damping device and/or the additional opening and closing cylinders, or may be separate means such as stops at the slide rails or dedicated telescopic rods.

Various modifications may be made by a person skilled in the art to the invention just described, only by way of non-limiting examples, and the scope of which is defined by the appended claims. For example, the thrust reverser 30 may alternatively have a “C” or “O” architecture. Furthermore, if the preferred embodiments described above relate to a design of a reverser with fixed deflection grids, these grids may alternatively be integrated into the movable structure of the reverser. Finally, if the closing part 86 that has been described previously preferably corresponds to an inter-flap part of the reverser, it could alternatively be one of the closing flaps 84 as described in FIGS. 6 and 7, without departing from the scope of the invention. The opening 78 and the opposing closing part 86 may be located at any other location on the wall 52, in particular for grid reversers without closing flap as described in the document U.S. Pat. No. 7,484,356, or with closing membranes as described in the document FR 3,076,864 A1.

The closing part may also open in a direction other than that presented in the preferred embodiment described above, without departing from the scope of the invention. For example, the closing part could pivot radially outwards, or be movable in axial or circumferential translation.

1. Thrust reverser (30) for an aircraft propulsion system, the reverser comprising a fixed structure (31) equipped with a radially inner delimiting wall (18) of a secondary flow path (21B) of the propulsion system intended to be traversed by a secondary flow (20B), the reverser also comprising a movable structure (29) comprising at least one movable reverser cover (33) having a cavity (54) delimited between a radially outer wall (50) and a radially inner wall (52) of the movable reverser cover (33), the radially inner wall (52) forming a radially outer delimiting wall of the secondary flow path (21B), the movable structure being movable in translation with respect to the fixed structure along a central longitudinal axis (A1) of the reverser, between an forward direct thrust position a reverse thrust position,
characterized in that the reverser also comprises a controlled system (72) for moving the movable cover (33) towards the reverse thrust position, by injecting air of the secondary flow (20B) through the radially inner wall (52) of the movable reverser cover, into said cavity (54).

2. Thrust reverser according to claim 1, characterized in that the controlled displacement system (72) comprises:
an air passage (78) through the radially inner wall (52) of the movable cover;
a closing part (86) fitted to the movable cover, the part (86) including a covering portion (87) of the air passage;
a control device (80) for holding the closing part (86) in the closing position of the air passage, and releasing this closing part so as to allow the injection of air from the secondary flow (20B) through the radially inner wall (52) of the movable reverser cover, into said cavity (54).

3. Thrust reverser according to claim 2, characterized in that the closing part (86) is mounted movably on the radially inner wall (52), being arranged radially inwardly with respect to the latter, between the closing position of the air passageway in which the closing part (86) is folded against the radially inner wall (52), and a protruding position radially inwardly in the secondary flow path (21B), in which it releases the air passage (78) and wherein it forms, preferably with its upstream axial end and together with the radially inner wall (52), an air introduction opening of the secondary flow (89) opened axially to the upstream side.

4. Thrust reverser according to claim 2, characterized in that the closing part (86) is mounted movably on the radially inner wall (52), being arranged radially outwards with respect to the latter, between the closing position of the air passageway in which the closing part (86) is folded against the radially inner wall (52), and a radially outwards protruding position, in which it opens the air passageway (78).

5. Thrust reverser according to any one of the preceding claims, characterized in that in the retracted reverse thrust position of the movable structure (29), the fixed structure (31) of the reverser and an upstream end (52a) of the radially retracted inner wall (52) of the movable reverser cover allow a passage opening (56) for air to appear between them through the secondary flow path (21B), the thrust reverser also comprising sealing means (84) of the secondary flow path, designed to divert at least a portion of the secondary flow (20B) toward the passage opening (56), and in that the closing part is a closing flap (84) of the secondary flow path (21B), belonging to said closing means, or in that the closing part is an interflap part (86) for reconstituting the secondary flow path (21B), arranged circumferentially between two closing flaps (84) of said closing means.

6. Thrust reverser according to any one of the preceding claims combined with claim 2, characterized in that it comprises one or more air passages (78) through the radially inner wall (52), the number thereof being between one and six, distributed circumferentially around the central longitudinal axis (A1).

7. Thrust reverser according to any one of the preceding claims, characterized in that the fixed structure (31) of the reverser comprises at least one deflection grid (32) arranged, in the advanced position of direct thrust of the movable structure, in the cavity (54) of the movable cover, being isolated from the secondary flow path by the radially inner wall (52) of the reverser cover (33).

8. Thrust reverser according to any one of the preceding claims, characterized in that it also includes a device (92) for damping the opening travel limit of the movable cover (33), in its movement from the forward direct thrust position to the rearward reverse thrust position.

9. Aircraft propulsion system (1), comprising a turbomachine (2) and a nacelle (3) comprising at least one fan cowling (14), as well as a thrust reverser (30) according to any one of the preceding claims.

10. Method for controlling a thrust reverser (30) according to any one of claims 1 to 8, characterized in that to drive the moving structure (33) from its forward direct thrust position to its rearward reverse thrust position, the method comprises a step of controlling the displacement system (72), such that air from the secondary flow (20B) is injected through the radially inner wall (52), into said cavity (54) of the movable cover, in order to cause it to move to the reverse thrust position.
